(19) United States
(12) Patent Application Publication
(10) Pub. No.: US 2023/0370324 A1
(43) Pub. Date: Nov. 16, 2023

(54) AUTOMATING INCIDENT RESPONSE FOR OUTAGE

(71) Applicant: Computer Sciences Corporation, Ashburn, VA (US)

(72) Inventors: Marc OGLESBY, Arlington, TX (US); Nick TAMBURRO, Brunswick West (AU); Betty LAU, Richmond Hill (CA); Ross GRAHAM, Lilydale (AU); Ya XUE, Chapel Hill, NC (US); Jun LIU, Cary, NC (US); Soroush RAZMYAR, Charlotte, NC (US)

(73) Assignee: Computer Sciences Corporation, Ashburn, VA (US)

(21) Appl. No.: 18/314,651

(22) Filed: May 9, 2023

Related U.S. Application Data
(60) Provisional application No. 63/340,690, filed on May 11, 2022.

(51) Int. Cl. H04L 41/0631; H04L 41/0659

(52) U.S. Cl. CPC H04L 41/0631; H04L 41/0661

(57) ABSTRACT

An exemplary method, for solving a problem with a network element within a network, includes first selecting a first set of pre-existing bots and first executing at least some of the selected first set of bots to change the network element and/or the network to solve the problem. The method further includes conducting a root cause analysis to generate recommendation(s) to correct the problem and in response to the first executing failing to solve the problem: second selecting, based on the recommendation(s), a second set of pre-existing bots to change the network element and/or the network to solve the problem, and second executing at least some of the selected second set of bots to solve the problem. Subsequently, the method includes generating, in response to the second executing failing to solve the problem, instructions to manually change the network element and/or the network to solve the problem.

### CROSS REFERENCE TO RELATED APPLICATIONS

The instant application claims priority to U.S. Provisional Application 63/340,690 entitled AUTOMATING INCIDENT RESPONSE FOR OUTAGE filed May 11, 2023, the contents of which are expressly incorporated by reference herein in its entirety.

### FIELD OF THE INVENTION

Various embodiments described herein relate generally to methods and systems for solving problems within a network. More specifically, various embodiments described herein relate to automating responses to predicted or detected outages within the network.

### BACKGROUND

Downtimes occurring due to a problem with a specific network element within a network or the network as a whole, are detrimental for any business and/or enterprise offering IT services to their customers. Users/customers facing downtime often raise service tickets indicating the problem, which are then manually addressed by service engineers. This approach is time-consuming, resource intensive, and prone to delays due to uncertainty in number of service tickets received during a time interval. The delay in remediating such problems further impacts the business operations of the enterprise or business severely. Therefore, there is a need to expedite the remediation process and effectively resolve the aforementioned problems.

### SUMMARY

According to an embodiment of the present disclosure, a method for solving a problem with a network element within a network is provided. The method comprises: first selecting a first set of pre-existing bots to address the problem; first executing at least some of the selected first set of pre-existing bots to change the network element and/or the network to solve the problem; conducting a root cause analysis (RCA) based on the problem to generate one or more root cause recommendations to correct the problem; in response to the first executing failing to solve the problem: second selecting, based on the one or more root cause recommendations, a second set of pre-existing bots to change the network element and/or the network solve the problem; second executing at least some of the selected second set of pre-existing bots to solve the problem; and generating, in response to the second executing failing to solve the problem, instructions for users to manually change the network element and/or the network to solve the problem.

The above embodiment may have various option features. The problem may include a full loss of service or a decline in service of the network element. Further, the problem may include a detected problem or a predicted problem. Each of the first set of pre-existing bots and second set of pre-existing bots may comprise one or more bots. The RCA and the first selecting may occur in parallel. Solving the problem may correspond to full restoration of a state of the network element before occurrence of the problem or partial restoration of the state of the network element before occurrence of the problem to a threshold. The network element may include at least one of: a server, a controller, a router, a switch, a controller, an application, and a database.

According to another embodiment of the present disclosure, a non-transitory computer readable media storing instructions for solving a problem with a network element within a network and programmed to cooperate with a processor to perform operations is provided. The operations comprise: first selecting a first set of pre-existing bots to address the problem; first executing at least some of the selected first set of pre-existing bots to change the network element and/or the network to solve the problem; conducting a root cause analysis (RCA) based on the problem to generate one or more root cause recommendations to correct the problem; in response to the first executing failing to solve the problem: second selecting, based on the one or more root cause recommendations, a second set of pre-existing bots to change the network element and/or the network solve the problem; second executing at least some of the selected second set of pre-existing bots to solve the problem; and generating, in response to the second executing failing to solve the problem, instructions for users to manually change the network element and/or the network to solve the problem.

The above embodiment may have various option features. The problem may include a full loss of service or a decline in service of the network element. Further, the problem may include a detected problem or a predicted problem. Each of the first set of pre-existing bots and second set of pre-existing bots may comprise one or more bots. The RCA and the first selecting may occur in parallel. Solving the problem may correspond to full restoration of a state of the network element before occurrence of the problem or partial restoration of the state of the network element before occurrence of the problem to a threshold. The network element may include at least one of: a server, a controller, a router, a switch, a controller, an application, and a database.

According to another embodiment of the present disclosure, a system is provided. The system includes a non-transitory computer readable media storing instructions for solving a problem with a network element within a network, and a processor programmed to cooperate with the instructions to perform operations comprising: first selecting a first set of pre-existing bots to address the problem; first executing at least some of the selected first set of pre-existing bots to change the network element and/or the network to solve the problem; conducting a root cause analysis (RCA) based on the problem to generate one or more root cause recommendations to correct the problem; in response to the first executing failing to solve the problem: second selecting, based on the one or more root cause recommendations, a second set of pre-existing bots to change the network element and/or the network solve the problem; second executing at least some of the selected second set of pre-existing bots to solve the problem; and generating, in response to the second executing failing to solve the problem, instructions for users to manually change the network element and/or the network to solve the problem.

The above embodiment may have various option features. The problem may include a full loss of service or a decline in service of the network element. Further, the problem may include a detected problem or a predicted problem. Each of the first set of pre-existing bots and second set of pre-existing bots may comprise one or more bots. The RCA and the first selecting may occur in parallel. Solving the problem may correspond to full restoration of a state of the network element before occurrence of the problem or partial restoration of the state of the network element before occurrence of the problem to a threshold. The network element may include at least one of: a server, a controller, a router, a switch, a controller, an application, and a database.

### DRAWINGS

Various embodiments in accordance with the present disclosure will be described with reference to the drawings, in which:

FIG. 1 illustrates a schematic representation of reactive and predictive resolution, according to an embodiment of the present disclosure.

FIG. 2 illustrates a schematic diagram for automating resolution, according to an embodiment of the present disclosure.

FIG. 3 illustrates a flowchart exemplifying steps to solve a problem by a bot seeker, according to an embodiment of the present disclosure.

FIG. 4 shows exemplary automation execution results to improve automation success rate.

FIG. 5 illustrates a flowchart of an example method for solving a problem with a network element within a network, according to an embodiment of the present disclosure.

FIG. 6 illustrates an example of a computing system for implementing a method that solves a problem with a network element within a network.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope and spirit of the claimed subject matter.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures and techniques may be shown without unnecessary detail in order to avoid obscuring example embodiments.

References to one or an embodiment in the present disclosure can be, but not necessarily are, references to the same embodiment; and such references mean at least one of the embodiments.

References to any “example” herein (e.g., “for example”, “an example of”, by way of example” or the like) are to be considered non-limiting examples regardless of whether expressly stated or not.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various features are described which may be features for some embodiments but not other embodiments.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Several definitions that apply throughout this disclosure will now be presented. The term “comprising” when utilized means “including, but not necessarily limited to”; it specifically indicates open-ended inclusion or membership in the so-described combination, group, series and the like. The term “a” means “one or more” unless the context clearly indicates a single element. The term “about” when used in connection with a numerical value means a variation consistent with the range of error in equipment used to measure the values, for which ±5% may be expected. “First,” “second,” etc., re labels to distinguish components or blocks of otherwise similar names but does not imply any sequence or numerical limitation. “And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities.

When an element is referred to as being “connected,” or “coupled,” to another element, it can be directly connected or coupled to the other element or intervening elements may be present. By contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

“Network” may refer to one or more network elements that are interconnected via communication paths. The network may include any number of software and/or hardware elements coupled to one another to establish the communication paths and route data/traffic via the established communication paths. Since a network may include one or more systems, and one or more systems may correspond to a network, hence the terms “network” and “system” are used interchangeably throughout the disclosure. “Network element” may comprise any element within the network that includes hardware, software, or combination of both. Each network element can also include suitable interfaces for receiving, transmitting, and/or otherwise communicating data and/or information in a network environment. As non-limiting examples, the network element includes at least one of: a server, a controller, a router, a switch, a controller, a service, an application, a database, and a storage. Further, the network element may be any component that is a part of a wireless network infrastructure such as but not limited to access points (on-premises or cloud), edge platforms, and the like.

“Event” refers to any activity within the network. The event may be general data for the network or specific data pertaining to one or more network elements within the network. The event may be associated with a timestamp and may be continuously generated similar to log data. “Incident” refers to specific activity data within the network that has a potential of causing a specific problem in the routine functioning of the network element or network. Any alert, trigger, log data, event, or measurable metrics can be an incident. As a non-limiting example, incident may be a specific event or a collection of events that have a probability of causing the problem in the network element or network. As another non-limiting example, the incident may be event(s) similar to one or more historical events that caused the problem within the network. As yet another non-limiting example, the incident may be specific data, indicating certain network activity, from a predictor that predicts probability of occurrence of the problem based on information contained in that data.

“Problem”, specifically within context of this disclosure, refers to any abnormal activity within the network that is a potential deterrent to the smooth functioning of the network. The problem may be detected or predicted. As a non-limiting example, the problem includes a full loss of service to one or more network elements within the network or to the network as a whole. As another non-limiting example, the problem includes a partial loss of service to the one or more network elements within the network or to the network as a whole. As yet another non-limiting example, the problem includes a degradation of service performance associated with one or more network elements within the network or the network as a whole. As yet another non-limiting example, the problem includes reduced or a decline in operational capacity of one or more network elements to a defined limit. As yet another non-limiting example, the problem includes a server outage detected or predicted within the network.

“Bot” refers to a software application that has been specifically programmed to perform certain functions or tasks. The bot is automated and is designed to execute a set of instructions without manual intervention. “Playbook” refers to a set of instructions, rules, suggestions, historical data, or any predefined data that is utilized to find solutions to a given problem. The playbook may contain one-to-one or one-to-many solutions for each problem. Further, the playbook can be triggered based on one or more triggers such as one or more events or incidents. Due to the nature of similarity, the terms “bot” and “playbook” are interchangeably used within the context of this disclosure. For example, selecting a playbook may refer to selecting a bot, and vice-versa.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Whenever a problem occurs within a network, the conventional approach is to indicate to the users/customers, who usually access/consume the network, regarding the downtime during which specific network elements/components will be unavailable or certain services will remain suspended. In case of scheduled/planned downtimes, the time to resolve the problem is still known to a certain degree. However, in case of unplanned or sudden network failures resulting in downtimes, the time to resolve the problem may vary drastically. Such situations are unwanted as they lead to loss of revenue and cause significant business disruption. Further, if the resolution is delayed then it costs extra manual resources to resolve the problem timely, which again adds to the cost for any business or enterprise. Hence, it is an objective of the present disclosure to automate responses to the problems, whether detected or predicted.

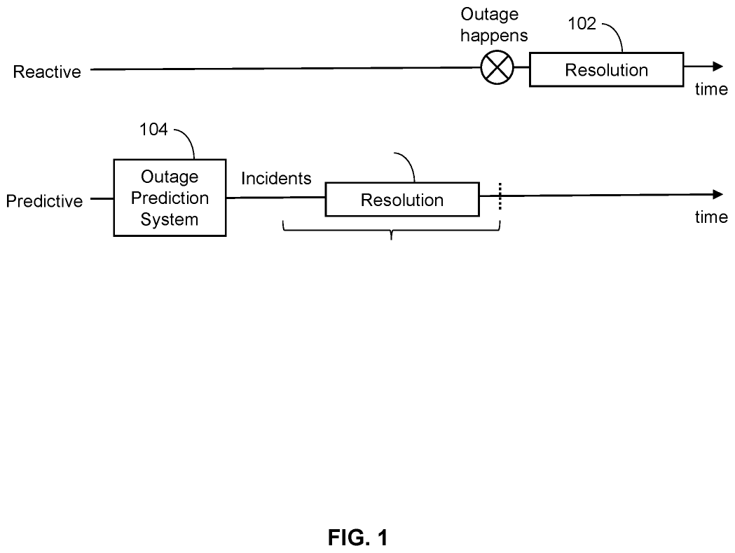

FIG. 1 illustrates a schematic representation of reactive and predictive resolution, according to an example embodiment. For better understanding of the present disclosure, an outage is considered as a non-limiting example of a problem in FIG. 1.

Referring to FIG. 1, reactive and predictive approaches to resolve the problem are disclosed. In a reactive approach, the problem such as an outage faced by a specific network element within a network happens at a certain point in time and resolution 102 is provided only after the problem has occurred or detected. The resolution 102 is implementation of a specific technique, method, and/or system, to solve the problem. The resolution techniques and methodologies offered by the resolution 102 will be discussed later in detail in the subsequent figures.

Using artificial intelligence (AI) and machine learning (ML) techniques, problems in a network, such as but not limited to server outage or any network element outage, can be predicted beforehand. A non-limiting example for predicting outages is disclosed in the co-filed U.S. Provisional Application No. entitled titled METHOD AND SYSTEM FOR OUTAGE PREDICTION, although the present disclosure is not limited to outage prediction. An outage prediction system, such as the one disclosed in the above-mentioned application, may be utilized as a non-limiting example to generally predict incidents that are potential candidates for causing any network element outage or specifically predict network element outage probability of events that qualify as incidents. Further, it is not necessary that incidents would be the only outcome of any network element outage prediction or problem prediction. One may apply the same concept to anomalies and alerts predicted as a result of monitoring specific network element(s) or the network as a whole.

In the predictive approach, a potential problem such as outage is predicted using an outage prediction system 104, such as the example discussed in above-mentioned application. Although a specific example of outage prediction is cited here but a person with ordinary skill in the art will understand that the prediction concept can be extended to any problem prediction within the network or with any specific network element without undue experimentation. In response to the outage prediction performed by the outage prediction system 104, incidents are generated as an output, and based on the generated incidents, the resolution 102 will be applied at X time, e.g., two hours, before the predicted outage. The predictive approach, hence, will proactively prevent the predicted outage before the outage occurs.

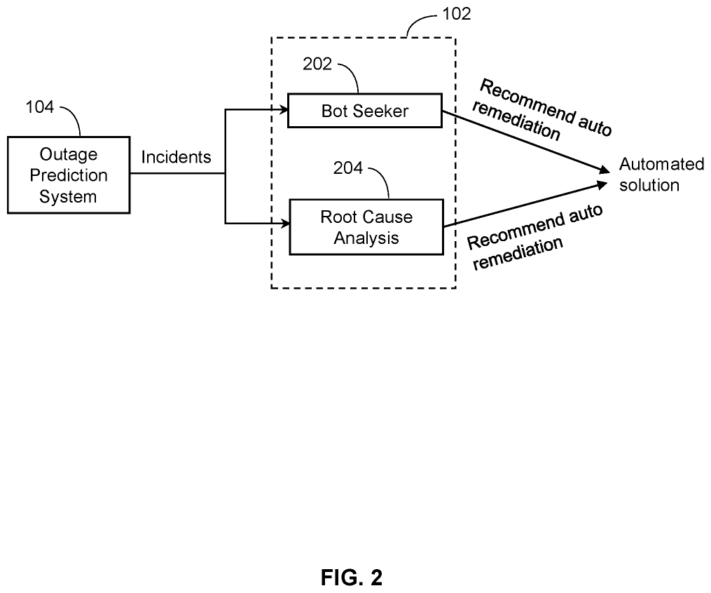

FIG. 2 illustrates a schematic diagram for automating resolution, according to an example embodiment. FIG. 2 will be explained in conjunction with FIG. 1.

Referring to FIG. 2, the outage prediction system 104 will generate incidents, similar to FIG. 1. The present disclosure discusses two techniques, namely bot seeker 202 and root cause analysis (RCA) 204 to solve the problem of outage prediction. Both the techniques may form a part of resolution 102 discussed in FIG. 1.

As the name suggests, the bot seeker 202 typically seeks bots for solving the problem. The bot seeker 202 includes a set of instructions, code, and/or computational logic to generate one or more recommendations for incoming incidents. Upon receiving the incident as a trigger, the bot seeker 202 executes instructions on one or more robotic platforms based on a set of pre-existing bots and generates one or more recommendations as an outcome of the execution. The recommendations include bot(s) recommended for auto remediation, i.e., certain pre-existing bot(s) are determined to be available and can be executed for preventing the incident that indicates a probable outage prediction. For such a recommendation, the resolution can be automated leading to an automation solution. The solution includes changing the network element and/or network to solve the predicted outage problem. Therefore, bot seeker 202 is one of the techniques by which the resolution 102, as discussed in FIG. 1, is provided.

The second technique, the RCA 204, is a technique that identifies the root cause(s) in relation to incoming incidents and prescribes remediation, such as bot(s), for resolution. The RCA 204 automatically consolidates all the pertinent data and telemetry related to network element(s) associated with the problem and derives root causes of the problem. The RCA 204 may run in parallel with the bot seeker 202. There are two phases of implementing the RCA technique on given set of data, i.e., training phase and real-time data phase, respectively. The RCA 204 can generate one or more RCA recommendations based on a suitable model that is trained using historical incidents/events/triggers and their associated root causes. Thus, an output of the trained model is then applied to the real-time data. Without limitation, diverse training models may be built or executed for training purpose of the RCA 204 and based on accuracy of results predicted, one may select best model that generates valid results/recommendation with consistent or improved performance over time.

Upon receiving an incident generated from the outage prediction system 104, the RCA 204 detects the root causes for that incident and generates a recommendation such as one or more pre-existing bots that can provide a resolution to fix the predicted outage. Such one or more pre-existing bots recommended based on the detected root causes are candidate(s) for auto remediation and the resolution can be automated leading to the automated solution. The solution includes change the network element and/or the network to solve the predicted outage problem. Therefore, the RCA 204 is another technique by which the resolution 102, as discussed in FIG. 1, is provided. Accordingly, the present disclosure describes two techniques for automating incident responses where a predicted problem is auto-resolved, thereby preventing repercussions of downtimes that otherwise users/customers accessing the network element or network would have faced if the problem had occurred. Both the techniques can be applied to the reactive approach as well where resolution is provided for the detected problem, as discussed in FIG. 1.

Without limitation, it may be ascertained that detection of similar output from a detection system, module, method, or technique may function analogously as the outage prediction system 104, in the disclosed embodiments. For example, the embodiments where a predicted incident or predicted outage probability is used as input will operate similarly as detected incident or detected outage probability. Further, the type of output from such modules can be different from incident or probability, such as an anomaly.

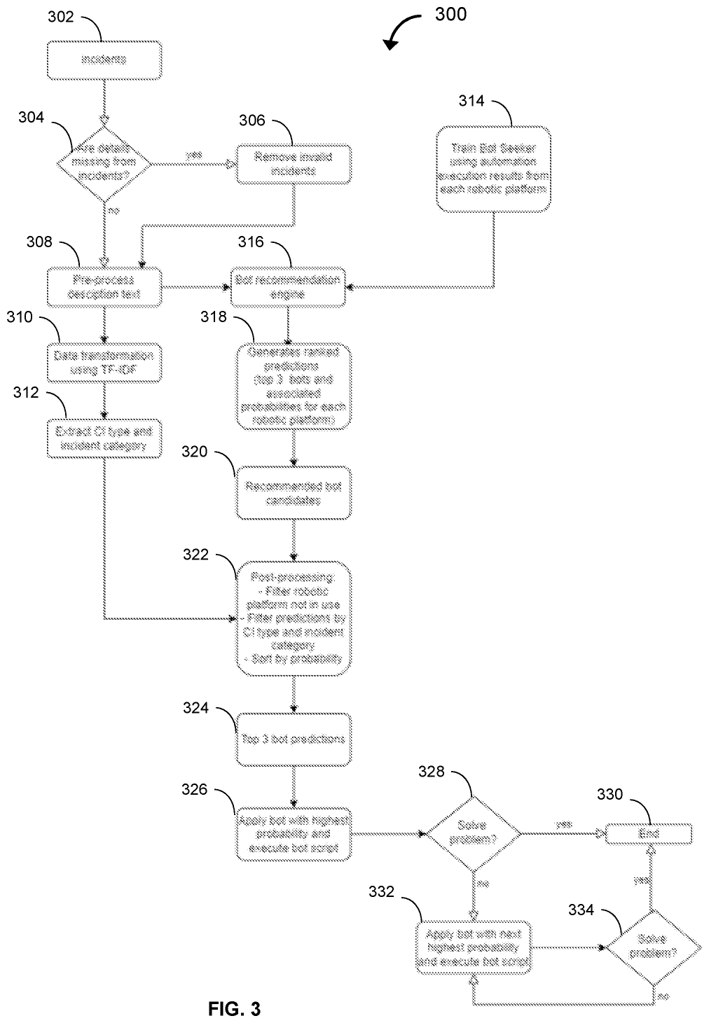

FIG. 3 illustrates a flowchart 300 exemplifying steps to solve a problem by the bot seeker 202. FIG. 3 will be explained in conjunction with FIG. 2 and FIG. 1. As discussed with reference to FIG. 2, the bot seeker 202 generates one or more recommendations such as bot(s) to perform auto remediation and self-heal for incidents. A procedure to generate the one or more recommendations by the bot seeker 202 will be detailed in accordance with FIG. 3.

The bot seeker 202 processes the incidents based on incident information and solution/playbook information. The incident information which is associated with an incident includes but is not limited to at least one of incident description, client name associated with the incident, a timestamp or time at which the incident (or event) is generated, a configuration item (CI) identity (ID), operating system, hardware type, application type (if the incident is tagged as an application incident), and so on. CI ID may correspond to ID of the network element for which the problem is being detected. In an embodiment, CI ID corresponds to server ID in the network when the incident indicates a probable server outage. Further, the solution/playbook information includes one or more valid playbooks per CI/incident type and available robot solutions for a customer/client.

Referring to FIG. 3, one or more incidents 302 i.e., output generated from the outage prediction system 104 as discussed previously, are received as an input. For the received incidents 302, it is determined at step 304 if details are missing from the respective incidents based on the incident information associated with the respective incidents.

If a result of the determination at step 304 is affirmative, then invalid incidents are removed at step 306. Invalid incidents include incidents such as but not limited to null, duplicate, and incidents with no description. A null incident corresponds to incident with no CI ID or not sufficient data for the bot seeker 202 to act on. After removing the invalid incidents at step 306, the flow proceeds to step 308.

If a result of the determination at step 304 is negative i.e., no details are missing from the incidents then also the flow proceeds to step 308. At step 308, description text associated with the respective incident is pre-processed. The pre-processing may include but is not limited to sub-steps such as converting the text to lower case for matching, extracting key terms (e.g., memory, database, and so on) to create a library of key terms, adding normalized key terms to the description if applicable (e.g., adding term Central Processing Unit or CPU for processor), and removing punctuation, file names, small unrelated words, and other common text processing steps.

After pre-processing the description text for the respective incidents, Term Frequency-Inverse Document Frequency (TF-IDF) transformation is performed at step 310 to output better or significant words. Once the transformation is performed at step 310, CI type (such as OS, hardware) and incident category is extracted at step 312 for respective incidents. This extraction is performed as additional information may be needed to confirm what bots should be used for solving the problem to improve an accuracy of the bot seeker 202. A result of the extraction performed at step 312 will be used later while performing post-processing at step 322.

Further, an output of the pre-processing is sent to a bot recommendation engine 316 which generates recommendations for bots based on training. The bot seeker 202 is trained using historical data from automation execution results from each robotic platform at step 314, based on bot usage that worked well and successfully self-healed or remediated the problems in the past. The training results are fed into or utilized by the bot recommendation engine 316 to generate the recommendations.

The bot recommendation engine 316 generates ranked predictions/recommendations such as top X bots and associated probabilities for each robotic platform by applying any classifier such as logistic regression. As a non-limiting example, top three bots may be predicted/recommended for each robotic platform. The generation step is used to determine most suitable playbooks or bots, the incident information is compared/matched against predefined solutions/playbooks, and the matched results are then ranked.

After generating the ranked predictions/recommendations at step 318, a certain number of recommendations, such as top X recommendations among the predictions/recommendations for robotic platforms, are provided as recommended bot candidates 320. Without limitation, there may be scenarios when recommendations include only one recommendation while there may be scenarios when there can be three or more than three recommendations. The bot seeker 202 can be programmed or trained to output a fixed or variable number of recommendations based on number of results, type of incidents, and other configurable factors.

Once the recommended bot candidates 320 are generated at step 318, post-processing is performed at step 322. The post-processing may include filtering robotic platform(s) that are not in use. In an embodiment, a specific user/customer/client may use only specific platform(s) among available robotic platforms so the filtering may be performed on that basis. After filtering based on the robotic platform, the remaining recommended bot candidates are filtered based on CI type and incident category using the output of extraction performed at step 312. Subsequently, the remaining bot candidates, after filtering based on CI type and incident category, may be sorted by probability. It will be apparent to one of ordinary skill that the invention is not limited to the number of post-processing steps performed, or an order in which the post-processing steps are performed.

After performing the post-processing, top X bot predictions/recommendations are recommended as an output of the bot seeker 202 at step 324.

Among the top X bot recommendations, the bot with highest probability is applied/selected and associated bot script is executed at step 326. After the bot script of the selected bot is executed, consequently, at step 328, it is checked if the problem to be solved such as server outage is solved as a result of the execution. If the predicted problem is solved, then the flow ends at step 330. For the sake of brevity and continuity, an example of the problem is considered to be as the predicted server outage. However, it will be apparent to a person with ordinary skill in the art that the embodiments of the disclosure are applicable to any other problem, either detected or predicted, with any other network element within the network.

Further, if the problem is not solved at step 328, then a bot with next highest probability is applied/selected and the associated bot script is executed. After the execution, it is again checked at step 334 if the (new) bot is able to solve the problem. If it is determined that the (new) bot is able to solve the problem, then the flow ends at step 330. Steps 332 and 334 are executed iteratively until all the recommended bots in the order of probability are executed and checked for solving the problem.

Therefore, auto execution is performed when the bot seeker 202 recommends bot(s) that are capable of resolving the problem. If one of the predicted/recommended bots is able to solve the problem then the bot seeker 202 is successful in self-healing and the predicted problem is prevented, thereby saving downtime for customers/clients/users that may have been caused due to occurrence of the problem if not prevented. This functionality of bot seeker 202 to automatically prevent the detected or predicted problem by auto-executing automation bots is called auto resolution, self-remediation, or self-healing. Further, the bot seeker 202 automatically recalibrates self-healing and self-remediation recommendations based on historic patterns from automation executions.

Further, there may be different scenarios that the bot seeker 202 may encounter once the recommendations are generated. Self-healing bots are capable of auto-resolving the detected or predicted problem. In another scenario, self-remediating bots are able to diagnose the problem and collect all the necessary data from the network element for problem resolution. In yet another scenario, when recommended bots have a high likelihood to fail, failure reasons are provided along with the recommendation to determine if the bot should be executed and actions that can be taken to improve automation success rate.

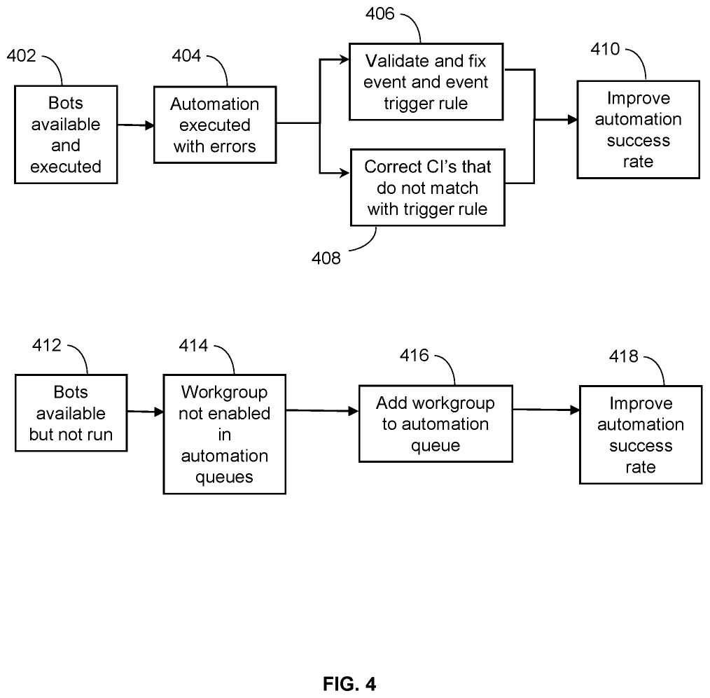

FIG. 4 shows exemplary automation execution results to improve automation success rate. FIG. 4 is explained in conjunction with previous figures.

Referring to FIG. 4, a first execution result 402 depicts bots are available and executed. However, upon an attempt to execute such bots, the automation is executed with errors, as depicted by block 404. A first corresponding action for such a scenario is to validate and fix event and event trigger rule, as depicted by block 406, of the corresponding bots that faced the first execution result 402. A second corresponding action is to make corrections to trigger rule or logic where CI is not matching, as depicted by block 408. As a result of the first and second actions for the first execution result 402, an improvement in automation success rate is gained as a possible outcome, as depicted by block 410.

A second execution result 412 depicts bots are available but not run. A cause of encountering the second execution result 412 may correspond to workgroup not being enabled in automation queues, as depicted by block 414. Based on the cause, a corresponding action may be to add workgroup to automation queue, as depicted by block 416, of the bot that faced the second execution result 412. As a result of the action for the second execution result 412, automation success rate is improved, as depicted by 418.

The above-mentioned bot execution results are used for failure analysis and to train a model on automation execution that fails; and the corresponding actions described herein are prescribed and used to improve automation operations and increase automation rate.

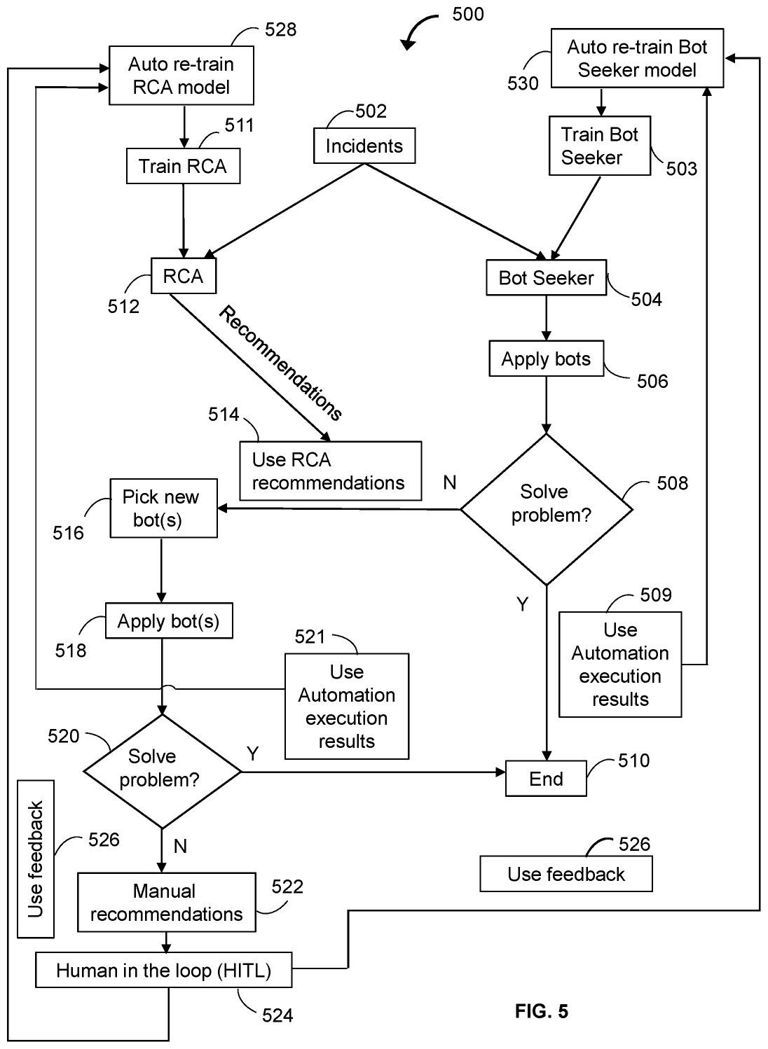

FIG. 5 illustrates a flowchart 500 for solving a problem with a network element within a network. For ease of reference and better understanding, FIG. 5 will be explained in conjunction with previous figures. The flowchart 500 depicts a step-by-step approach for resolving problems that are either detected or predicted within the network.

Traditional methods to resolve problems within the network include performing RCA after the problem has occurred to understand the root cause(s) that caused the problem. This is a laborious process and involves tremendous amount of coordination and across functional groups to perform the investigation; it is time consuming. Further, mean time to investigate (MTTI) and Mean time to recovery (MTTR) are considerably high for manual resolution approach.

According to the embodiments presented herein, the solution includes an approach where it is determined whether an automated solution can be applied for a predicted problem using recommendation(s) from a bot seeker. If the bot seeker is not able to resolve the predicted problem with the recommended bot, then RCA is performed. The RCA results in recommendation(s) based on identified root cause(s) of the predicted problem. The RCA recommendations will be utilized to select and apply bot(s) in order to solve the predicted problem. Further, in case the problem still remains unresolved after RCA, then instructions are generated for a service engineer or solutioning team to resolve the problem. Thus, with the above-mentioned approach, RCA is conducted when there is a need, which removes the delay in waiting on RCA for every predicted or detected incident when it isn't needed. Further, such a solution is efficient than traditional methods because automation results in resolving the problem swiftly. Further, the RCA recommendations can be used as auxiliary information for service engineer in manual redressal without the need of performing RCA from scratch.

The flowchart 500 begins at block 502, where incidents, outage probabilities, triggers, alerts, or anomalies (referred to as “incidents”) are received from any prediction module as discussed previously. Without limitation, flowchart 500 will function similarly with a detection module that detects real-time incidents similar to the prediction module.

The received incidents are supplied as an input to a bot seeker 504. The bot seeker 504 is trained previously at block 503 to enable the bot seeker 504 to generate recommendations based on the learned data. The generated output of the bot seeker 504 includes recommendation(s) for one or more bots that are determined to be capable of solving the problem. As a non-limiting example, top X bots (such as three bots) may be recommended as an output of the bot seeker 504.

In response to the recommendation of bots sought from the bot seeker 504, one or more bots are applied and associated bot script is executed at block 506 in an attempt to solve the problem. In a non-limiting example, recommended bot(s) may be checked for solving the problem from highest to lowest probability.

In response to a result of execution of the bots at block 506, the method proceeds to block 508 where it is determined if the executed one or more bots are able to solve the problem.

If the determination at block 508 is affirmative, then the method ends at block 510. Since the problem was solved in response to the application of bots at block 506, hence such successful automation execution results 509 from the bot seeker 504 are used to auto re-train bot seeker model at block 530. The trained bot seeker model is in turn used to train the bot seeker at block 503, thereby improving an accuracy of the bot seeker 504 in generating bot recommendations. Therefore, if a pre-existing bot or playbook is successfully executed at block 506, which leads to solving the predicted problem then no RCA is needed for the predicted incident, either by the system or by a service engineer. This is a fast way of resolving the problem automatically even before it occurs by using the bot seeker in accordance with the embodiments disclosed herein.

However, if the problem is not solved using the bots recommended by the bot seeker at block 508 then it is determined that the underlying problem may be more complex and requires deeper insights to resolve it. Accordingly, RCA technique comes into picture when the bot seeker fails to solve the problem.

RCA analysis may be performed at RCA 512 in parallel with the bot seeker 504, based on incidents from the prediction module as an input from block 502. In order to perform RCA, RCA model was previously built and trained at block 511. In an embodiment, recommendations from RCA 512 pertaining to RCA may be used after determining at block 508 that bots selected or attempted to execute via the bot seeker fail to execute and solve the problem. Once RCA is performed at RCA 512, RCA recommendations are generated based on root cause(s) identified for the problem. The RCA recommendations are then used at 514 to pick/select new bots at block 516.

Therefore, the RCA recommendations are not needed if execution of the bots at block 506 resolved the problem at block 508. When the bots are not able to successfully solve the problem at block 508, then at block 516 new bots are selected based on the RCA recommendations 514 in view of the prior (unsuccessful) attempts to resolve the problem.

At block 518, the bots selected at block 516 are executed in an attempt to address the problem. Once the bots selected at block 516 are applied at block 518, it is determined at block 520 whether the selected (new) bots are able to solve the problem. If the selected new bot(s) are able to solve the problem, then the method proceeds to end at block 510. Since the problem was solved in response to the application of bots at block 518, hence such successful automation execution results 521 from RCA are used to auto re-train RCA model at block 528. The trained RCA model is in turn used to train the RCA at block 511, thereby improving an accuracy of the RCA 512 in generating RCA recommendations. Therefore, using RCA, solution to the predicted problem can be automated leading to faster resolution if the recommended bots by the RCA are available and execute successfully to resolve the predicted problem.

However, if it is determined that the selected new bot(s) are unable to solve the predicted problem at block 520 then the method proceeds to block 522 for manual resolution only if previous techniques to solve the problem fail, such as bot seeker 504 and RCA 512.

At block 522, a service engineer is provided with incident and/or problem related information including information pertaining to failure scenarios, failure reasons, and recommended corrective actions that may be prescribed to the service engineer for actioning. Non-limiting examples of failure scenarios, failure reasons, and recommended corrective actions were previously discussed in reference to FIG. 4. The service engineer, with the aid of such historical data on the RCA and/or bot seeker output, manually determines or recommends one or more alternative bots for solving the problem. The alternative bots determined by the service engineer are captured as human feedback. As depicted by block 526, the human feedback is used to auto re-train the RCA model at block 528 and auto re-train the bot seeker model at block 530. Such a method in which human intelligence is used to auto re-train RCA and bot seeker models is called as “Human in the loop” (HITL) as depicted by block 524. Therefore, the RCA model and the bot seeker model may be auto re-trained using either automation execution results from recommended bots or feedback from the service engineer based on RCA and/or bot seeker output. As a result of auto-training the RCA and bot seeker models as described, automation success rate is improved.

The manual solution includes by changing the state or operation of one or more network elements and/or the network to outright avoid occurrence of the predicted problem or reduce within an acceptable margin the probability of occurrence of the predicted problem. Even in the manual resolution approach of the present disclosure, the service engineer has access to previous results of RCA 512 and bot seeker 504. This provision of information may be automatically provided to the service engineer once it is determined that the bot seeker 504 and RCA 512 have failed to resolve the problem. Therefore, MTTI and MTTR are still reduced than conventional manual resolution approaches.

In the above embodiments, RCA 512 occurs in parallel with activity at 504-508. However, the invention is not so limited, and RCA 512 may begin before bot seeker 504, in parallel with other blocks, after block 508, or in response to a negative determination at block 508. The invention is not limited to the timing of the operations.

In the disclosed embodiments, when the problem is not resolved by either the selected bots by the bot seeker or the bots selected as a result of RCA, still conducting RCA would yield RCA recommendations based on one or more root causes of the problem. Operations gain efficiencies by simply verifying the RCA recommendations, performing action, and providing feedback, hence reducing MTTR tremendously. Therefore, the RCA disclosed herein is time efficient as compared to an approach where resolution of the problem is a manual process with involvement of a service engineer.

Further, the solutions discussed throughout the disclosure enable self-healing, self-remediation, and auto resolution of the predicted or detected problem(s) in contrast to manual resolution to address and/or resolve downtimes/outages/problems within the network, which are time consuming and cause significant business disruption. In other way, automating incident responses either solves the detected/predicted problem or becomes an opportunity to increase automation success rate.

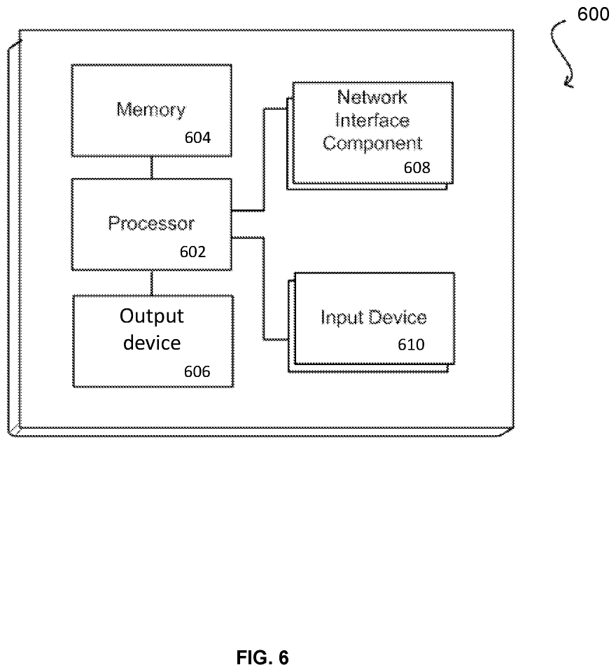

FIG. 6 illustrates an example of a computing system 600 for implementing a method that solves a problem with a network element within a network. The computing system 600 includes computerized devices, such computerized device can include hardware elements that may be electrically coupled via a bus, the elements include at least one processor (central processing unit (CPU) or processing unit) 602, that is communicatively coupled to other elements of the computing system 600 such as a memory 604, an output device 606, a network interface component 608, and an input device 610. The processor 602 can include any general-purpose processor as well as a special-purpose processor where software instructions are incorporated into the actual processor design. The processor 602 may essentially be a completely self-contained computing system, containing multiple cores or processors, a bus, memory controller, cache, etc. A multi-core processor may be symmetric or asymmetric.

The memory 604 may include one or more storage devices, such as disk drives, optic storage devices, and solid-state storage devices such as random-access memory (“RAM”) or read-only memory (“ROM”), as well as removable media devices, memory cards, flash cards, etc. The memory 604 may also be a storage media and a computer readable media that contains code, or portions of code, can include any appropriate media known or used in the art. The storage media and communication media are, but not limited to, volatile and non-volatile, removable and non-removable media implemented in any method or disclosure for storage and/or transmission of information such as computer readable instructions, data structures, program modules, or other data, including RAM, ROM, EEPROM, flash memory or other memory disclosure, CD-ROM, digital versatile disk (DVD) or other optic storage, magnetic cassettes, magnetic tape, magnetic disk storage or other magnetic storage devices, or any other medium which can be used to store the desired information and which can be accessed by a system device or the processor 602.

The storage media may be coupled to other devices of the computing system 600, such as a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information.

An environment including the computing system 600 can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate.

The computing system 600 includes at least one input device 610 (e.g., a mouse, keyboard, controller, touch screen, or keypad), and at least one output device 606 (e.g., a display device, printer, or speaker). The network interface component 608 supports communication between the computing system 600 other external systems or devices. Most embodiments utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In an embodiment, the computerized device includes a Web server (not shown), the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The computing system 600 may be implemented in a serverless computing environment and/or cloud computing environment such as but not limited to Amazon's AWS, Microsoft's Azure, Google cloud, OpenStack, local docker environment (e.g., private cloud with support for implementing containers), local environment (e.g., private cloud) with support for virtual machines or microservices, and the like.

The computing system 600 and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Various embodiments discussed or suggested herein can be implemented in a wide variety of operating environments, which in some cases can include one or more user computers, computing devices, or processing devices which can be used to operate any of a number of applications. User or client devices can include any of a number of general-purpose individual computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network. Based on the disclosure and teachings provided herein, an individual of ordinary skill in the art will appreciate other ways and/or methods to implement the various embodiments.

The specification and drawings are to be regarded in an illustrative rather than a restrictive sense. It will, however, be evident that various modifications and changes may be made thereunto without departing from the broader spirit and scope of the invention as set forth in the claims.

We claim:

1. A method for solving a problem with a network element within a network, the method comprising:
first selecting a first set of pre-existing bots to address the problem;
first executing at least some of the selected first set of pre-existing bots to change the network element and/or the network to solve the problem;
conducting a root cause analysis (RCA) based on the problem to generate one or more root cause recommendations to address the problem;
in response to the first executing failing to solve the problem:
second selecting, based on the one or more root cause recommendations, a second set of pre-existing bots to change the network element and/or the network to solve the problem; and
second executing at least some of the selected second set of pre-existing bots to solve the problem; and
generating, in response to the second executing failing to solve the problem, instructions for users to manually change the network element and/or the network to solve the problem.

2. The method of claim 1, wherein the problem includes a full loss of service or a decline in service of the network element.

3. The method of claim 1, wherein the problem includes a detected problem or a predicted problem.

4. The method of claim 1, wherein each of the first set of pre-existing bots and second set of pre-existing bots comprises one or more bots.

5. The method of claim 1, wherein the RCA and the first selecting occur in parallel.

6. The method of claim 1, wherein solving the problem corresponds to full restoration of a state of the network element to an original state of the network element.

7. The method of claim 1, wherein solving the problem corresponds to partial restoration of a state of the network element to a threshold.

8. A non-transitory computer readable media storing instructions for solving a problem with a network element within a network, programmed to cooperate with a processor to perform operations comprising:
first selecting a first set of pre-existing bots to address the problem;
first executing at least some of the selected first set of pre-existing bots to change the network element and/or the network to solve the problem;
conducting a root cause analysis (RCA) based on the problem to generate one or more root cause recommendations to address the problem;
in response to the first executing failing to solve the problem:
second selecting, based on the one or more root cause recommendations, a second set of pre-existing bots to change the network element and/or the network to solve the problem; and
second executing at least some of the selected second set of pre-existing bots to solve the problem; and
generating, in response to the second executing failing to solve the problem, instructions for users to manually change the network element and/or the network to solve the problem.

9. The non-transitory computer readable media of claim 8, wherein the problem includes a full loss of service or a decline in service of the network element.

10. The non-transitory computer readable media of claim 8, wherein the problem includes a detected problem or a predicted problem.

11. The non-transitory computer readable media of claim 8, wherein each of the first set of pre-existing bots and second set of pre-existing bots comprises one or more bots.

12. The non-transitory computer readable media of claim 8, wherein the RCA and the first selecting occur in parallel.

13. The non-transitory computer readable media of claim 8, wherein solving the problem corresponds to full restoration of a state of the network element to an original state of the network element.

14. The non-transitory computer readable media of claim 8, wherein solving the problem corresponds to partial restoration of a state of the network element to a threshold.

15. A system, comprising:
a non-transitory computer readable media storing instructions for solving a problem with a network element within a network
a processor programmed to cooperate with the instructions to perform operations comprising:
first selecting a first set of pre-existing bots to address the problem;
first executing at least some of the selected first set of pre-existing bots to change the network element and/or the network to solve the problem;
conducting a root cause analysis (RCA) based on the problem to generate one or more root cause recommendations to address the problem;
in response to the first executing failing to solve the problem:
second selecting, based on the one or more root cause recommendations, a second set of pre-existing bots to change the network element and/or the network to solve the problem; and
second executing at least some of the selected second set of pre-existing bots to solve the problem; and
generating, in response to the second executing failing to solve the problem, instructions for users to manually change the network element and/or the network to solve the problem.

16. The system of claim 15, wherein the problem includes a full loss of service or a decline in service of the network element.

17. The system of claim 15, wherein the problem includes a detected problem or a predicted problem.

18. The system of claim 15, wherein each of the first set of pre-existing bots and second set of pre-existing bots comprises one or more bots.

19. The system of claim 15, wherein the RCA and the first selecting occur in parallel.

20. The system of claim 15, wherein solving the problem corresponds to full restoration of a state of the network element to an original state of the network element.
